(19) United States
(12) Patent Application Publication
(10) Pub. No.: US 2012/0094876 A1
(43) Pub. Date: Apr. 19, 2012

(54) DESIGNED DRILLING FLUIDS FOR ECD MANAGEMENT AND EXCEPTIONAL FLUID PERFORMANCE

(76) Inventors: Dale Jamison, Humble, TX (US); Jeff Miller, Spring, TX (US); Charlotte Burress, Seabrook, TX (US)

(21) Appl. No.: 12/907,515

(22) Filed: Oct. 19, 2010

(51) Int. Cl. C09K 8/02

(52) U.S. Cl. 507/100

(57) ABSTRACT

Designed drilling fluids and methods of designing and using designed drilling fluids are disclosed. In one embodiment, a method of designing a drilling fluid comprises the step of determining a Design Space comprising specified ranges for one or more drilling fluid properties. The method further comprises determining a Final Fluid Formulations Set comprising drilling fluid compositions having drilling fluid properties compatible with the Design Space and satisfying one or more Performance Criterion. The method further comprises selecting a subset of drilling fluid compositions from the Final Fluid Formulations Set. The method further comprises preparing a drilling fluid based on the subset of drilling fluid compositions.

### BACKGROUND

The present invention relates generally to drilling fluids useful during drilling operations in subterranean formations and, at least in some embodiments, to novel methods for designing drilling fluids for, among other things, equivalent circulating density (“ECD”) management and optimal fluid performance utilizing parameters which would not typically be considered for hydraulic optimization.

As used herein, “drilling fluid” refers to a fluid that is circulated into a well bore through the inside of a drill string, out through a drill bit, and up to the surface through the annulus between the drill string and the well bore to facilitate the drilling operation. Drilling fluids can be any of a number of liquid and gaseous fluids and mixtures of fluids and solids (as solid suspensions, mixtures and emulsions of liquids, gases and solids) used in operations to drill well bores into the earth. In the art, the term “drilling fluid” is often used synonymously with the term “drilling mud,” although some prefer to reserve the term “drilling fluids” for more sophisticated and well-defined “muds.” Classification of drilling fluids has been attempted in many ways, often producing more confusion than insight. One classification scheme is based only on the drilling fluid composition by singling-out the component that clearly defines the function and performance of the fluid: (1) water-based, (2) non-water-based, and (3) gaseous (pneumatic). Each category has a variety of subcategories that overlap each other considerably. Drilling fluids are used throughout the drilling process, and usually comprise a base fluid and solids (such as weighting agents). The various functions of drilling fluids may include removing drill cuttings from the well bore, cooling and lubricating the drill bit, aiding in support of the drill pipe and drill bit, and providing a hydrostatic head to maintain the integrity of the well bore walls and prevent well blowouts.

A drill-in fluid is a special fluid designed exclusively for drilling through the reservoir section of a well bore. Oftentimes, the reasons for using a drill-in fluid are: (1) to drill the reservoir zone successfully, which may often require a long, horizontal drain hole, (2) to minimize damage and maximize production of exposed zones, and (3) to facilitate the well completion needed, which can include complicated procedures. The term drilling fluid as used herein includes drill-in fluids.

Once the well bore has been drilled to a desired depth, the drill string and drill bit may be removed from the well bore and the drilling fluid may be left in the well bore to provide hydrostatic pressure on the formation penetrated by the well bore, e.g., to prevent the flow of formation fluids into the well bore. Depending on the depth of the well bore and whether or not any problems are encountered in introducing the pipe string into the well bore, the drilling fluid may remain relatively static in the well bore for a relatively long time period, for example, up to 24 hours or longer.

Drilling fluids have tended to be designed by a mud engineer's “gut feel,” in reaction to field performance, or by trial and error, in conjunction with other programs used to predict drilling performance. Traditionally, mud engineers would first mix products together and then measure and analyze properties to see what the mixture achieved. For example, in many drilling operations, drilling fluids may be selected to have sufficient carrying capacity to remove the bit cuttings from the well bore. Materials, such as hydroxyethyl cellulose, welan gum, guar gum, xanthum gum, polyacrylamide/polyacrylate, or carboxymethyl cellulose, might be added ad hoc to adjust the carrying capacity of the drilling fluid. The resulting arrangements have been arrived at somewhat arbitrarily, which can be an inefficient and time consuming process for determining the composition of the drilling fluid, and which may or may not lead to drilling fluids producing the desired drilling characteristics. These traditional methods could be analogized to buying clothes “off the rack,” thereby resulting in imprecise and imperfect fitting.

The components of a chosen drilling fluid may be selected to support a drilling operation in accordance with the characteristics of a particular geological formation and to meet the requirements of the drilling operation. For example, oil or synthetic fluid-based muds are normally used to drill swelling or sloughing shales, salt, gypsum, anhydrite, or other evaporite formations, hydrogen sulfide-containing formations, and hot (greater than about 300° F.) well bores. When drilling fluid components are selected, many fluid characterization parameters may be considered. Fluid properties such as rheology, fluid loss, and emulsion stability over time and temperature variations, among many others, may determine the suitability of drilling fluids for a specific well or drilling operation. Ranges for these parameters are often identified in either customer performance specifications or American Petroleum Institute (“API”) specifications. Further considerations regarding the drilling fluid may include that it be environmentally acceptable, mixable at the surface, readily available, cost effective, and have the desired density and fluid loss characteristics. Some of these specifications may vary from operator to operator, largely due to the individual operator's experienced-based knowledge, prior success, or even in some cases vendor preferences. This may lead to drilling fluids which reflect a specific operator's point of view, rather than a comprehensive optimal design perspective.

### SUMMARY

The present invention relates generally to drilling fluids useful during drilling operations in subterranean formations and, at least in some embodiments, to novel methods for designing drilling fluids for, among other things, equivalent circulating density (“ECD”) management and optimal fluid performance utilizing parameters which would not typically be considered for hydraulic optimization.

One embodiment of the present invention provides a method of designing a drilling fluid. The method comprises determining a Design Space comprising specified ranges for one or more drilling fluid properties. The method further comprises determining a Final Fluid Formulations Set comprising drilling fluid compositions having drilling fluid properties compatible with the Design Space and satisfying one or more Performance Criterion. The method further comprises selecting a subset of drilling fluid compositions from the Final Fluid Formulations Set. The method further comprises preparing a drilling fluid based on the subset of drilling fluid compositions.

In another embodiment, the present invention provides a designed drilling fluid. According to this embodiment, the drilling fluid is designed by a method comprising determining a Design Space comprising specified ranges for one or more drilling fluid properties. The method further comprises determining a Final Fluid Formulations Set comprising drilling fluid compositions having drilling fluid properties compatible with the Design Space and satisfying one or more Performance Criterion. The method further comprises selecting a subset of drilling fluid compositions from the Final Fluid Formulations Set.

In yet another embodiment, the present invention provides a method of using a designed drilling fluid in a well bore in a subterranean formation. The method comprises designing a drilling fluid. According to this embodiment, designing a drilling fluid comprises determining a Design Space comprising specified ranges for one or more drilling fluid properties. The method further comprises determining a Final Fluid Formulations Set comprising drilling fluid compositions having drilling fluid properties compatible with the Design Space and satisfying one or more Performance Criterion. The method further comprises selecting a subset of drilling fluid compositions from the Final Fluid Formulations Set.

The features and advantages of the present invention will be readily apparent to those skilled in the art. While numerous changes may be made by those skilled in the art, such changes are within the spirit of the invention.

### BRIEF DESCRIPTION OF THE DRAWING

These drawings illustrate certain aspects of some of the embodiments of the present invention, and should not be used to limit or define the invention.

FIG. 1 is a block diagram depicting a possible data processing system for implementing the methods of the present invention in accordance with an embodiment of the present invention.

FIG. 2 is a block diagram depicting possible systems for obtaining and/or transmitting data in accordance with an embodiment of the present invention.

FIG. 3 illustrates a method for designing drilling fluids in accordance with an embodiment of the present invention.

FIG. 4 further illustrates a method for designing drilling fluids in accordance with an embodiment of the present invention.

### DESCRIPTION

The present invention relates generally to drilling fluids useful during drilling operations in subterranean formations and, at least in some embodiments, to novel methods for designing drilling fluids for, among other things, equivalent circulating density (“ECD”) management and optimal fluid performance utilizing parameters which would not typically be considered for hydraulic optimization.

There may be several potential advantages to the methods and compositions of the present invention, only some of which are alluded to herein. One of the many potential advantages may be that the resultant drilling fluids allow the operation to achieve an ECD most appropriate to a specified well bore. In contrast to traditional methods, the present invention can be analogized to having clothes custom tailored, thereby resulting in greater precision in fitting. Consequently, another possible advantage may be that resultant drilling fluid may provide optimal fluid performance for the specified well bore. Another such advantage is that the design process may require less time and resources than previous methods for selecting and/or formulating a drilling fluid. The design process may thereby be iteratively repeated to dynamically adjust to conditions which change throughout the specified drilling operation. In some instances, the design process may incorporate real-time analysis of drilling fluids and variable operational parameters.

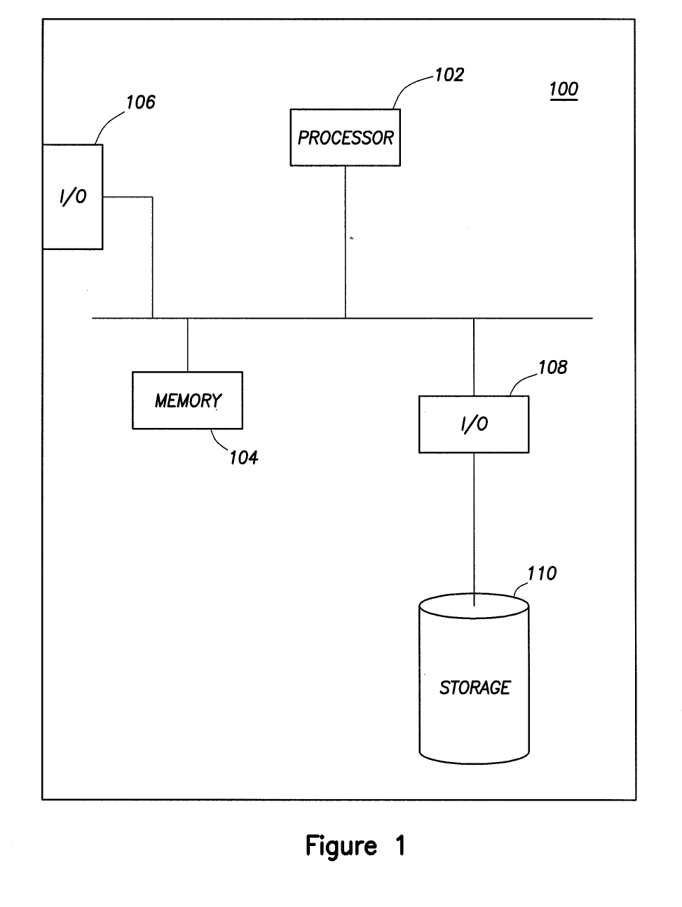

The methods of the present invention may be implemented utilizing any suitable data processing system, including computer systems, handheld devices, or any other suitable device. Thus, in one aspect, the present invention may relate to a data processing system for designing drilling fluids. A suitable data processing system may include a processor, memory, storage, and software instructions residing in the storage and operable on the processor to implement the methods of the present invention. Referring now to FIG. 1, a computer system suitable for use with the present invention is depicted and generally referenced by numeral 100. Computer system 100 comprises a processor 102, memory 104, input out (“I/O”) interface 106, I/O interface 108, and storage 110. Processor 102 may comprise one central processing unit or may be distributed across one or more processors in one or more locations. Memory 104 may be communicatively coupled to processor 102. Memory 104 may be read-only memory, random-access memory, or the like. I/O interfaces 106 and I/O interfaces 108 may be communicatively coupled to processor 102. I/O interfaces 106 and 108 may be any suitable systems for connecting computer system 100 to a communication link, such as a direct connection, a private network, a virtual private network, a local area network, a wide area network (“WAN”), a wireless communication system, or combinations thereof; storage devices, such as storage 110; external devices, such as a keyboard, a monitor, a printer, a voice recognition device, or a mouse; or any other suitable system. In some embodiments, storage 110 may be directly communicatively coupled to processor 102. Storage 110 may comprise any device suitable for storing data to be processed, including, but not limited to, compact disc drives, floppy drives, hard disks, and the like. Software instructions (not shown) may reside in storage 110 and may be transferred into memory 104 through I/O interface 108 at the direction of processor 102. The software instructions may enable the computer system 100 to accept input and criteria related to drilling fluids and determine a ranking of possible drilling fluids based on the input and criteria. The selection criteria may be given by a user, for example, through I/O interface 106, or may be specified in the software instructions. The software instructions may further generate a display, for example, on I/O interface 106, of scores for possible drilling fluids. Additionally, the software instructions may determine, based on scores for possible drilling fluids, one or more preferred drilling fluids. Those of ordinary skill in the art will appreciate that suitable data processing systems may comprise additional, fewer, and/or different components than those described for computer system 100.

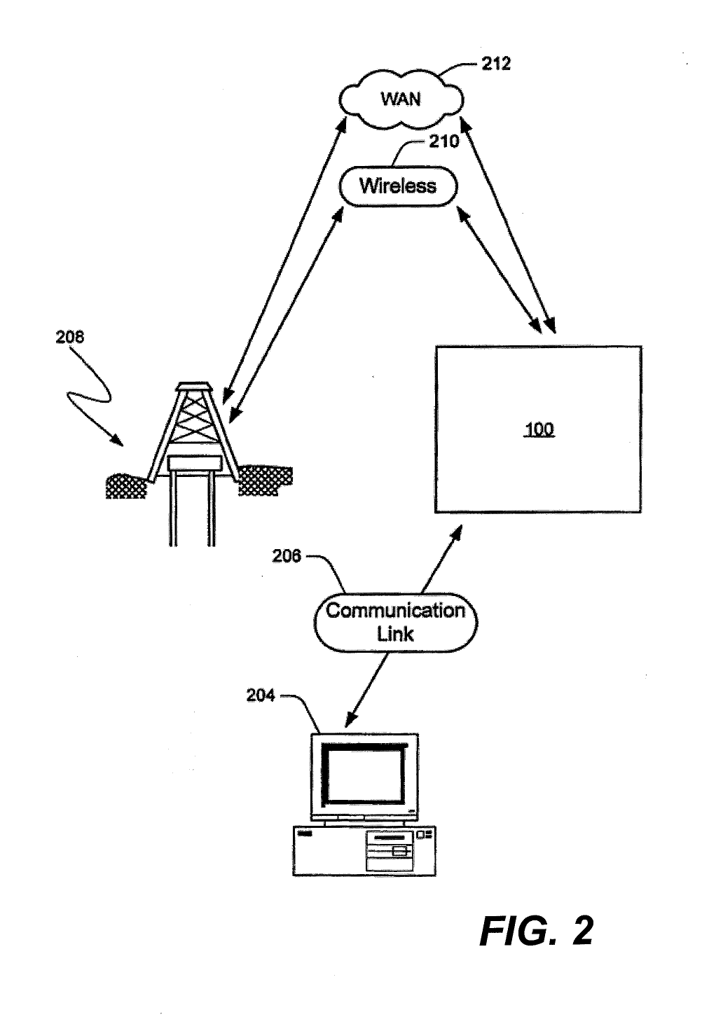

To design drilling fluids utilizing the methods of the present invention, computer system 100 should be able to obtain and transmit data needed therefor. FIG. 2 is a depiction of possible systems for obtaining and/or transmitting data by computer system 100 in accordance with one embodiment of the present invention. In one embodiment, computer system 100 may obtain data from and/or transmit data to a user of computer system 100 via suitable I/O means, such as a keyboard, a mouse, a voice recognition device, and/or a monitor (not shown) that are communicatively coupled to computer system 100 via I/O interfaces 106, 108 (depicted on FIG. 1). As used herein, “user” is defined to include real persons, data processing systems (e.g., computer systems, etc.), or any other suitable mechanism. In some embodiments, the user may be associated with a provider of well drilling operations or be a customer of such provider of well drilling operations. In other embodiments, computer system 100 may obtain data from and/or transmit data to a user of a second data processing system over a communication link, e.g., to a user of second computer system 204 that is communicatively coupled to computer system 100 via communication link 206. Communication link 206 may include a direct connection, a private network, a virtual private network, a local area network, a WAN (e.g., an Internet-based communication system), a wireless communication system (e.g., a satellite communication system, telephones), combinations thereof, or any other suitable communication link. In yet another embodiment, computer system 100 may obtain data from and/or transmit data to a well site 208 over a communication link. In these embodiments, data may be obtained from and/or transmitted to well site 208 over any suitable communication link, such as wireless communication system 210 (e.g., a satellite communication system) or WAN 212 (e.g., an Internet-based communication system). One of ordinary skill in the art will recognize other suitable systems over which computer system 100 may obtain and/or transmit data for a particular application.

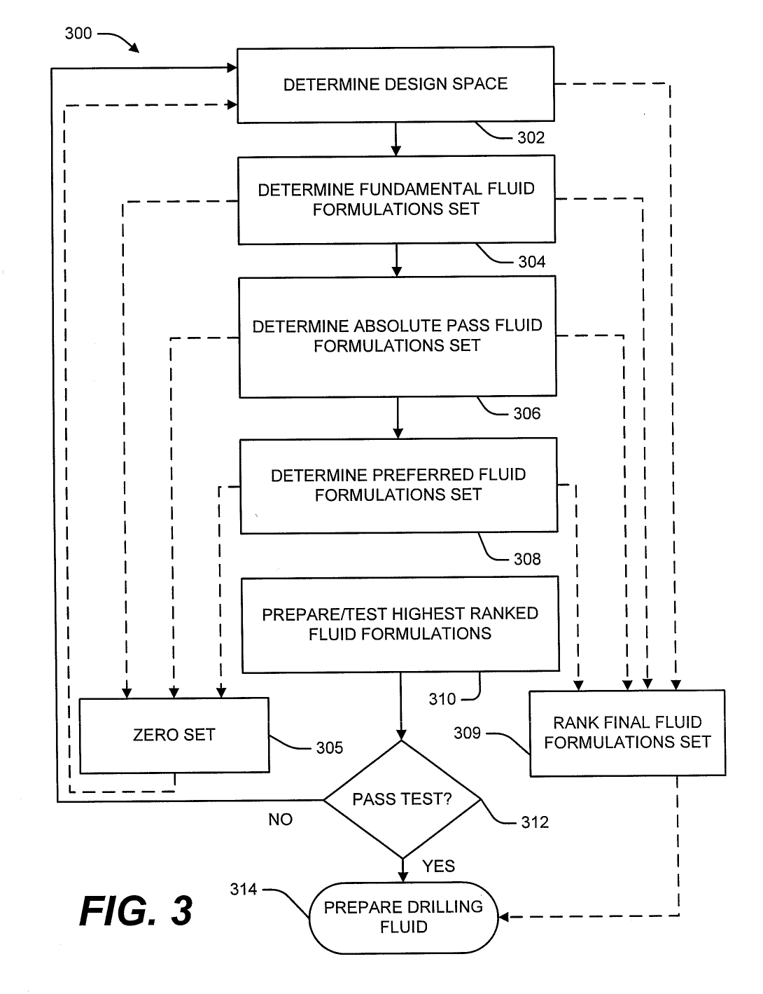

Referring to FIG. 3, a method 300 is shown for designing a drilling fluid in accordance with an embodiment of the present invention. As will be described in greater detail, the method may begin by determining the Design Space at 302. The method may progress by refining the Design Space to determine a Final Fluid Formulations Set which satisfies one or more Performance Criteria at 303. In some embodiments, output from determining a Final Fluid Formulations Set 303 may be captured in Feedback Set 305 to be used as feedback for one or more iterative repetitions of determining a Design Space 302. In some embodiments, step 303 may be omitted. In such instances, the output from step 302 may result in a Final Fluid Formulations Set. In some embodiments, the Final Fluid Formulations Set may be ranked according to a weighted normalization, resulting in a ranked Final Fluid Formulations Set at 309. Laboratory samples of a subset of drilling fluids from the Final Fluid Formulations set may be tested at 310. For example, laboratory samples representing drilling fluids with the highest rankings in the Final Fluid Formulations Set may be prepared and tested at 310. If one or more of the samples pass the test at 312, operational quantities of drilling fluids with such compositions may be prepared at 314, and the method may conclude. If, however, none of the samples pass the test at 312, the method may iterate to step 302, wherein the Feedback Set 305 and the results from the test at 312 may provide input to the procedure for determining a Design Space at 302. In some embodiments, one or more of steps 303, 310, 311, and 312 may be omitted, according to the methods of the invention.

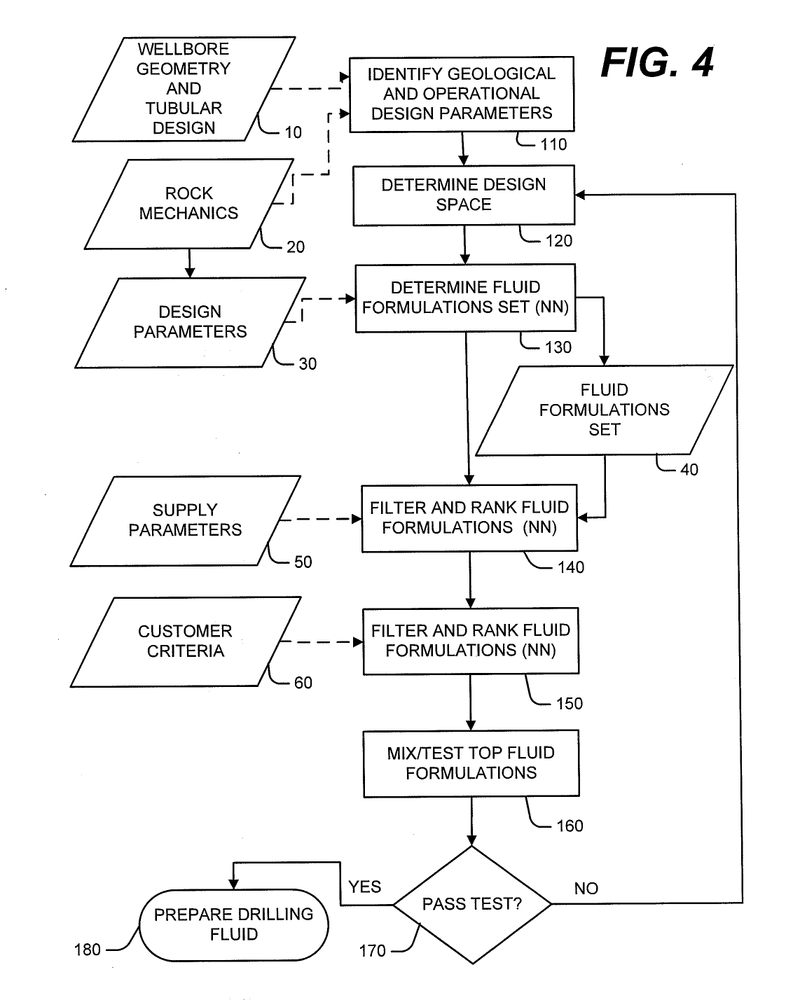

As illustrated in FIG. 4, step 303, determining a Final Fluid Formulations Set, may comprise one or more similar, but distinct, steps. When present in the method, the one or more similar steps may occur in the order discussed, wherein output from a preceding step may provide input to a subsequent step. For example, step 303 may comprise determining a Fundamental Fluid Formulations Set at 304. In some embodiments, output from determining a Fundamental Fluid Formulations Set at 304 may be captured in Feedback Set 305 to be used as feedback for one or more iterative repetitions of determining a Design Space 302. When present in the method, output from step 304 may also provide input to steps 306 or 308. Step 303 may sometimes comprise determining an Absolute Pass Fluid Formulations Set at 306. In some embodiments, output from determining an Absolute Pass Fluid Formulations Set at 306 may be captured in Feedback Set 305 to be used as feedback for one or more iterative repetitions of determining a Design Space at 302. When present in the method, output from step 306 may also provide input to step 308. Further, step 303 may comprise determining a Preferred Fluid Formulations Set at 308. In some embodiments, output from determining a Preferred Fluid Formulations Set at 308 may be captured in Feedback Set 305 to be used as feedback for one or more iterative repetitions of determining a Design Space at 302. One or more of steps 304, 306, and 308 may be omitted, according to some embodiments. In such instances, the output from the last step to be performed from the group of steps 302, 304, 306, and 308 may result in a Final Fluid Formulations Set. In some embodiments, the output may be ranked according to a weighted normalization, resulting in a ranked Final Fluid Formulations Set at 309. In some embodiments, as few as one of the steps 304, 306, 308, 310, 311, and 312 may be performed.

In order to design a drilling fluid which accounts for many of the significant Performance Criterion, a complex mathematical model may be utilized, according to some embodiments of the invention. The calculations may be performed by a computer program, such as a C-program or a program developed using a spreadsheet program such as Microsoft®Excel®. Alternatively, in certain instances wherein many of the complicating factors are not present, these steps may be carried out manually and/or experimentally as determined by a system or drilling fluid engineer. In some embodiments, artificial neural networks (“ANNs”) may utilize specified parameters as inputs in steps throughout the overall design process to result in an optimal drilling fluid. As would be understood by one of ordinary skill in the art, several methods exist to build ANNs. In some embodiments, a back propagation algorithm may provide a basic means of reducing error. In such embodiments, the inputs may be propagated through the hidden layers of the ANN to compute an output value. This output may then be compared to the actual output value, resulting in an error value. To reduce this error value, a backward pass through the ANN may occur, where the error may be passed to the input and hidden layers resulting in different weight changes. A forward pass with the weight changes may be made once more through the ANN, resulting in an iterative error reduction. Using this method, inputs and outputs may be tailored to build a network which suits each particular step of the design process.

Referring now to step 302, an example procedure for determining a Design Space, according to one embodiment of the invention, will be discussed in greater detail. As used herein, the term “Design Space” refers to a representation of a set of potential ranges for actual drilling fluid properties which are related to hydraulics, such as density and rheology parameters. (When discussing drilling fluids, rheology parameters are often expressed in terms of the Herschel-Buckley model, but it should be understood that other models (e.g., Bingham or Power-Law) may be used within the scope of this invention.) In some embodiments, the representation may be an abstract model, compatible with logical or mathematical functions. For example, an abstract representation may be one or more multi-dimensional arrays. Alternatively, an abstract representation may be a database structure. In other embodiments, the representation may be a physical model, such as a collection of sample drilling fluids.

Initially, appropriate Design Space input parameters may be determined. Appropriate Design Space input parameters specifying potential ranges for drilling fluid properties may be determined to comply with a variety of parameters. For example, in some embodiments, appropriate Design Space input parameters may be determined to comply with given operational design parameters. In other embodiments, appropriate Design Space input parameters may be determined to comply with given geological parameters. In still other embodiments, appropriate Design Space input parameters may be determined to comply with information previously obtained, such as output captured in Feedback Set 305, results from the test at 312 from previous iterations of method 300, or any combination thereof. Example operational design parameters may include, but are not limited to flow rate; hole geometry, orientation, width, depth, and extent (reach of the well); casing and drill pipe sizes and configurations; drill pipe rotations per minute, sliding, sliding/rotation ratio, and rate of penetration; drill bit size and type; configuration of specialty drilling tools; bottom-hole assembly (“BHA”) design; and operational requirements for drilling fluid plastic viscosity (“PV”), yield point (“YP”), oil-to-water ratio (“OWR”), compressibility, thermal expansion, heat transfer, and water phase salinity (“WPS”). Example geological parameters may include, but are not limited to, fracture pressure, pore pressure, formation composition, well bore porosity, in situ fracture density, overburden gradient, maximum and minimum horizontal stresses, permeability, and shear strength. In some embodiments, operational design parameters or geological parameters may be estimated from measurements taken during drilling, estimated from calculations known in the art, obtained from drilling simulations conducted for drilling fluid design, or any combination thereof.

Continuing with step 302, software, such as DFG™ Software with DrillAhead® Hydraulics Module, available from Halliburton Fluid Systems of Houston, Tex., may be used to determine a Design Space representing optimal ranges for density and rheology parameters. As would be understood by one of ordinary skill in the art, the rheology of fluids, such as drilling fluids, may be mathematically described by the Herschel-Buckley equation:

τ=τ₀+K(γ)ⁿ Eq. 1.

where n represents the power law exponent, K represents the consistency, γ represents the shear rate, τ represents the shear stress, and τ₀ represents the yield stress. In one embodiment of the system, the Design Space may include only those solutions that maintain ECD in a prescribed range while maintaining other operational conditions and achieving good cuttings transport. As would be understood by one of ordinary skill in the art with the benefit of this disclosure, ECD is the effective density exerted by a circulating fluid against the formation that takes into account the pressure drop in the annulus above the point being considered. ECD may be calculated as:

ECD=d+P/0.052*D Eq. 2.

where d is the mud weight (in pounds-per-gallon, or “ppg”), P is the pressure drop in the annulus between depth D and surface (in pounds-per-square-inch, or “psi”), and D is the true vertical depth (in feet, or “ft”). ECD is an important parameter in avoiding kicks (flow of reservoir fluids into the well bore caused by the pressure in the well bore being less than that of the formation fluids) and losses (flow of mud into the formation through fissures, fractures, or caverns, sometimes caused by the mud pressure being greater than the formation fracture gradient), particularly in wells that have a narrow window between the fracture gradient and pore-pressure gradient. In some embodiments, the constraints of the prescribed ECD range may vary as a function of time.

The density of the drilling fluid may be a primary consideration in designing the correct drilling fluid for a chosen operation. A given density may be selected, for instance, to maintain the hydrostatic pressure within the well bore to prevent shallow water flows. As would be understood by one of ordinary skill in the art with the benefit of this disclosure, the density of the drilling fluid may directly relate to the prescribed ECD range.

In some instances, the fracture gradient (“FG”), which is the pressure gradient at which a specific formation interval breaks down and accepts fluid, generally stated in psi/ft or kilopascal-per-meter, or “kPa/m”, and pore pressure (“PP”), which is the pressure of fluids within the pores of a reservoir, usually hydrostatic pressure, or the pressure exerted by a column of water from the formation's depth to sea level, may be significant determinants of well bore design and operating pressure ranges. As would be understood by one of ordinary skill in the art with the benefit of this disclosure, FG and PP can influence selection of the prescribed ECD range. A variety of conventional, predictive tools may be used to determine the FG and PP of a formation, based on formation type, rock mechanics, well bore trajectory, tubular design criteria, and other physical conditions or offset well data.

Referring now to step 304, an example procedure for determining a Fundamental Fluid Formulations Set, according to one embodiment of the invention, will be discussed in greater detail. As used herein, the term “Fundamental Fluid Formulations Set” refers to a representation—either abstract or physical—of a set of potential actual drilling fluid compositions which possess drilling fluid properties within the ranges of the Design Space and which satisfy additional criteria based on supply parameters (such as product availability, supply and operational logistics, and economic factors). In some embodiments, the drilling fluid compositions of the Fundamental Fluid Formulations Set satisfy additional criteria based on information obtained in previous iterations of the methods of the invention. Potential inputs for step 304 may include the Design Space from step 302, supply parameters, and information obtained in previous iterations of the methods of the invention. Supply parameters may distinguish certain drilling fluids from others when selecting optimal solution sets for a particular well. As an example, product availability and sourcing logistics may eliminate an otherwise acceptable drilling fluid as a useable solution. At step 304, the Design Space may be filtered based on supply parameters to eliminate unsuitable drilling fluids. Remaining drilling fluids may also be ranked according to these same supply parameters, resulting in a ranked Fundamental Fluid Formulations Set. In some embodiments, the ranking may be dynamic and may be repeated throughout the drilling operation. In other words, the supply parameters may change as new well bore is drilled and drilling fluids are consumed in field operations. The Fundamental Fluid Formulations Set may be re-filtered and re-ranked at step 304 in response to these dynamic changes. In some embodiments, a ANN may be utilized to determine a ranked Fundamental Fluid Formulations Set. Inputs for step 304 may then provide target input criteria for the ANN. If the Fundamental Fluid Formulations Set is dynamically re-filtered and re-ranked, the previous Fundamental Fluid Formulations Set also may provide target input criteria for the ANN.

Referring now to step 306, an example procedure for determining an Absolute Pass Fluid Formulations Set, according to one embodiment of the invention, will be discussed in greater detail. As used herein, the term “Absolute Pass Fluid Formulations Set” refers to a representation—either abstract or physical—of a set of potential actual drilling fluid compositions which possess drilling fluid properties within the ranges of the Design Space, which satisfy additional criteria based on supply parameters (when present in the method), and which satisfy additional criteria based on performance constraints that are typically not related to hydraulics. In some embodiments, the drilling fluid compositions of the Absolute Pass Fluid Formulations Set satisfy additional criteria based on information obtained in previous iterations of the methods of the invention. Potential inputs for step 306 may include the Design Space from step 302, the Fundamental Fluid Formulations Set from step 304, performance constraints, and information obtained in previous iterations of the methods of the invention. Such performance constraints may include, for example, target ranges for fluid loss emulsion stability, High Temperature High Pressure (“HTHP”) filtration test results, Particle Size Distribution (“PSD”), water phase salinity, and pH. At step 306, the Fundamental Fluid Formulations Set may be filtered based on performance constraints to eliminate unsuitable drilling fluids, resulting in an Absolute Pass Fluid Formulations Set. Remaining drilling fluids may also be ranked according to these same performance constraints, resulting in a ranked Absolute Pass Fluid Formulations Set. In some embodiments, the ranking may be dynamic and may be repeated throughout the drilling operation. The Absolute Pass Fluid Formulations Set may be re-filtered and re-ranked at step 306 in response to these dynamic changes. In some embodiments, a ANN may be utilized to determine a ranked Absolute Pass Fluid Formulations Set. Target input criteria for the ANN may include the Design Space, the Fundamental Fluid Formulations Set, and the performance constraints. If the Absolute Pass Fluid Formulations Set is dynamically re-filtered and re-ranked, the previous Absolute Pass Fluid Formulations Set also may provide target input criteria for the ANN.

Referring now to step 308, an example procedure for determining a Preferred Fluid Formulations Set, according to one embodiment of the invention, will be discussed in greater detail. As used herein, the term “Preferred Fluid Formulations Set” refers to a representation—either abstract or physical—of a set of potential actual drilling fluid compositions which possess drilling fluid properties within the ranges of the Design Space, satisfy additional criteria based on supply parameters (when present in the method), satisfy additional criteria based on performance constraints that are typically not related to hydraulics (when present in the method), and which satisfy criteria from customers, customer-related entities, operators, consultants, or trade associations (collectively, “customer criteria”). In some embodiments, the drilling fluid compositions of the Preferred Fluid Formulations Set satisfy additional criteria based on information obtained in previous iterations of the methods of the invention. Potential inputs for step 308 may include the Design Space from step 302, the Fundamental Fluid Formulations Set from step 304, the Absolute Pass Fluid Formulations Set from step 306, customer criteria, and information obtained in previous iterations of the methods of the invention. The customer criteria may include, but are not limited to, product availability; supply and operational logistics; economic and political factors; environmental considerations, such as lime concentration; emulsion stability; thermal stability; gel strength; fluid loss criteria; contamination resistance; performance under aging tests; performance under stress tests; settling or sag performance; operational temperature limits; requirements relating to formation stability, damage, swell, or sloughing; clean-up requirements; and factors discussed or recommended in trade publications, such as American Petroleum Institute (“API”) specifications. Customer criteria may impart additional filtering and ranking criteria for selecting optimal solution sets for a particular drilling operation. For example, a customer may require that a fluid has a fluid loss less than a specified amount, which would eliminate possible solutions from the Absolute Pass Fluid Formulations Set. At step 308, the Absolute Pass Fluid Formulations Set may be filtered and ranked based on customer criteria to eliminate unsuitable drilling fluids, resulting in a Preferred Fluid Formulations Set. In some embodiments, a ANN may provide performance intelligence based on customer criteria for each of the remaining formulations in the Preferred Fluid Formulations Set.

In some embodiments, one or more of steps 304, 306, and 308 may be omitted, according to the methods of the invention. In such instances, the output from the last step to be performed from the group of steps 302, 304, 306, and 308 may be ranked according to a weighted normalization, resulting in a Final Fluid Formulations Set at 309. As used herein, the term “Final Fluid Formulation Set” refers to a representation—either abstract or physical—of a set of potential actual drilling fluid compositions which possess drilling fluid properties within the ranges of the Design Space and satisfying one or more Performance Criterion. Moreover, the weighted normalization may be based on Performance Criterion and may require complex ANNs to produce meaningful results. As used herein, “Performance Criterion” refers to criteria previously discussed, including drilling fluid properties such as operational design parameters and geological parameters, supply parameters, performance constraints, and customer criteria. In some embodiments, a “Final Fluid Formulation Set” satisfies additional criteria based on supply parameters, additional criteria based on performance constraints that are typically not related to hydraulics, ranking criteria from customers, customer-related entities, operators, consultants, or trade associations, criteria from information obtained in previous iterations of the methods of the invention, and any combination thereof. The Final Fluid Formulations Set may comprise a normalized ranking with unequal weightings for various criteria. In other instances, the Final Fluid Formulations Set may comprise an absolute ranking based on a small number (as few as one) ranking criteria. There may be instances wherein the criteria weightings are substantially equal. One of ordinary skill in the art with the benefit of this disclosure should be able to determine when and to what extent normalization should be used.

Referring now to step 310, an example procedure for preparing and testing a subset of compositions from the Final Fluid Formulations Set, according to one embodiment of the invention, will be discussed in greater detail. Laboratory samples of actual drilling fluids represented by certain drilling fluid compositions from the Final Fluid Formulations Set may be prepared and tested. For example, an actual drilling fluid represented by the highest ranked composition from the Final Fluid Formulations Set may be tested by performing a drilling simulation. The drilling simulation may include tests for one or more characteristics, including, but not limited to, tests for settling/barite sag, formation swelling, rheological properties, long-term performance, static aging, thermal stability, and cross-contamination. If one or more of the samples pass the test at 312, the most favorable sample of actual drilling fluid may be selected based on a combination of the relative test performance and other characteristics related to the abstract composition. Operational quantities of the actual drilling fluid with the most favorable abstract composition may be prepared for use in the field at step 314. If, however, none of the samples test successfully at 312, the method may iterate to step 302, wherein the Feedback Set 305 and the results from the test at 312 may provide input to the procedure for determining a Design Space at 302. Thus, actual drilling fluid may be designed for ECD management and optimal fluid performance.

In some embodiments, the preceding steps may be iteratively applied during use of the actual drilling fluid in the field with real-time analytics. For example, real-time analysis of the operational quantities of the drilling fluids may be performed with the apparatus and methods disclosed in U.S. patent application Ser. No. 12/041,056 to Jamison, filed on Mar. 3, 2008, which is herein incorporated by reference. Output from the real-time analytics may provide iterative input to the procedure for determining a Design Space at 302. Additionally, variations in any of the operational parameters may be incorporated in subsequent iterations of the method. Thus, drilling fluid may be designed for real-time ECD management and optimal fluid performance.

In some embodiments, ANNs may be utilized to perform filtering and ranking calculations. The calculations of each of steps 304, 306, 308, and 309, may be determined by a single ANN or by individual ANN intelligence. The output of each of these steps may provide an ordinal ranking of drilling fluids, referred to herein as “Formulation Performance.” The Formulation Performance may be treated absolutely or normalized by different means. Normalization may allow ordering or weighting of the relative importance of each Performance Criterion, previously addressed as operational design parameters, geological parameters, supply parameters, performance constraints, and customer criteria. As would be understood by one of ordinary skill in the art with the benefit of this disclosure, weighting factors may be derived from the collective operational knowledge of industry experts. Thus, the relationship between Formulation Performance, Performance Criterion, and Weight may be expressed as:

Formulation Performanceⱼ=Σᵢ(Performance Criterionᵢⱼ*Weightᵢⱼ) Eq. 3.

In addition to weighted Performance Criterion, an experiential soft knowledge base may be used to further enhance the Formulation Performance. This ranking method may be formulated using a variety of techniques including ordinal ranking and normalization methods or alternatively using soft knowledge inputs into a ANN solution. In the process of ordering the relative performance rankings, this may be treated as just another Performance Criterion or a completely separate one. In this case the Formulation Performance may be treated as follows:

$$Formulation {Performance}_{j} = {Σ}_{i} ( ( ( Performance {Criterion}_{ij} * {Weight}_{ij} ) * Weight Major {Component}_{j 1} ) + ( Experience Based {Performance}_{j} * Weight Major {Component}_{j 2} ) ) . \qquad Eq . 4$$

The same methods may be used to capture intelligence from global and continuously updated databases. In such embodiments, ANN solutions may be used to analyze the success and performance of drilling fluids based on historical and ongoing data. Thus, the Formulation Performance may be expressed as:

$$Formulation {Performance}_{j} = {Σ}_{i} ( ( ( Performance {Criterion}_{ij} * {Weight}_{ij} ) * Weight Major {Component}_{j 1} ) + ( Experience Based {Performance}_{j} * {WeightMajorComponent}_{j 2} ) + ( Database {Performance}_{j} * Weight Major {Component}_{j 3} ) ) . \qquad Eq . 5$$

In one aspect, the invention provides drilling fluids for drilling operations in subterranean formations. In one or more embodiments, the drilling fluids may be prepared in accordance with a drilling fluid that has been designed according to method 300. The resultant drilling fluids of the present invention may be applied to many subterranean applications. The general nature of the subterranean applications may include, but are not limited to, oil and gas wells, water wells, storage facilities, mines, and recovery of underground resources. Suitable subterranean applications may include, but are not limited to, drilling operations, production stimulation operations, work-over, and well completion operations. Examples of suitable subterranean applications may be found in U.S. Pat. No. 6,002,985 to Stephenson, filed May 6, 1997.

To facilitate a better understanding of the present invention, the following examples of certain aspects of some embodiments are given. In no way should the following examples be read to limit, or define, the entire scope of the invention.

### EXAMPLES

Well data, including Bottom Hole Assembly and string design, is provided as input to DFG™ Software with DrillAhead® Hydraulics Module to generate a range of values for Herschel-Buckley rheology parameter (n), viscosity (K), and yield stress (τ₀), as in step 302. τ₀ is determined to be between about 5 to 6 lb/100 ft² to provide good cuttings transport and to prevent barite sag. n is determined to be less than about 0.800 to ensure a shear thinning fluid. K is determined to be less than about 0.200 lb/100 ft² to achieve ECD values between about 14.0 and 14.5 lb/gal. From this, surface rheological values, as would be measured by a Faun® Model 35 Viscometer, are computed, as reflected in Table 1.

TABLE 1

| RPM | Dial Reading |
|---|---|
| 600 | 54 |
| 300 | 33 |
| 200 | 26 |
| 100 | 17 |
| 6 | 7 |
| 3 | 6 |

An ANN is provided with input, including calculated surface rheological values, estimated OWR, estimated high-temperature/high-pressure (“HTHP”) fluid loss values, estimated 10-second and 10-minute gels, and estimated electrical stability (“ES”). Additionally, physical properties of two preferred base oils, ACCOLADE® and ENCORE®, each commercially available from Halliburton of Houston, Tex., are input. Specifically, the ANN is provided with the inputs shown in Table 2.

TABLE 2

| Property | Input Value |
|---|---|
| n | 0.765 |
| K (lb/100 ft²) | 0.288 |
| τ₀ | 5.5 |
| 600 RPM | 52 |
| 300 RPM | 33 |
| 3 RPM | 6 |
| OWR | 80/20; 75/25; 70/30 |
| HTHP fluid loss (mL) | 4.0 |
| 10 sec gel (lb/100 ft²) | 6 |
| 10 min gel (lb/100 ft²) | 6 |
| ES (v) | 300 |
| Mud Weight (ppg) | 13.5 |

The ANN determines an initial set of drilling fluid formulations, as in step 302. Evaluation of the initial set of drilling fluid formulation indicates that the lime concentration, predicted at 3 lb/bbl for each of the fluids, is too elevated to satisfy certain performance constraints, as in step 306. This feedback is used, as in step 305, to decrease the lime concentration to about 0.5 lb/bbl, the concentrations for base oil, calcium chloride, water, and barite are calculated using DFG™ Software, in a second iteration of step 302. The predicted, modified formulations for the fluids are shown in Table 3.

TABLE 3

| | ACCOLADE ® | ENCORE ® |
|---|---|---|
| bbl | 0.581 | 0.583 |
| LE SUPERMUL ™, lb | 6 | 5 |
| Lime, lb | 0.5 | 0.5 |
| ADAPTA ™, lb | 2 | 2 |
| Water, bbl | 0.149 | 0.149 |
| Calcium chloride, lb | 18.1 | 18.1 |
| RHEMOD L ™, lb | 1.4 | 1.2 |
| BAROID ®, lb | 303.4 | 306.7 |
| Rev Dust, lb | 20 | 20 |
| TAU-MOD ®, lb | — | — |

The formulations in Table 3 are mixed and hot rolled at 150° F. for sixteen hours, as in step 310. The rheological parameters are measured: τ₀ for ACCOLADE® measures 13.25 lbs/100 ft², and τ₀ for ENCORE® measures 10.4 lbs/100 ft². Due to the discrepancy between the measured rheological parameters and the input rheological parameters, τ₀=5.5 lbs/100 ft², the test fails at 312, and the formulations are adjusted in a third iteration of step 302 as indicated in Table 4.

TABLE 4

| | ACCOLADE ® | ENCORE ® |
|---|---|---|
| bbl | 0.551 | 0.585 |
| LE SUPERMUL, lb | 6 | 5 |
| Lime, lb | 0.5 | 0.5 |
| ADAPTA, lb | 0.5 | 2 |
| Water, bbl | 0.188 | 0.149 |
| Calcium chloride, lb | 22.8 | 18.1 |
| RHEMOD L, lb | — | 0.5 |
| BAROID, lb | 296.3 | 306.9 |
| Rev Dust, lb | 20 | 20 |
| TAU-MOD, lb | — | — |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method of designing a drilling fluid comprising:
(a) determining a Design Space comprising specified ranges for one or more drilling fluid properties;
(b) determining a Final Fluid Formulations Set comprising drilling fluid compositions having drilling fluid properties compatible with the Design Space and satisfying one or more Performance Criterion;
(c) selecting a subset of drilling fluid compositions from the Final Fluid Formulations Set; and
preparing a drilling fluid based on the subset of drilling fluid compositions.

2. The method of claim 1, wherein (b) comprises at least one step selected from the group consisting:
(i) determining a Fundamental Fluid Formulations Set comprising drilling fluid compositions having drilling fluid properties compatible with the Design Space and satisfying one or more supply parameters;
(ii) determining an Absolute Pass Fluid Formulations Set comprising drilling fluid compositions having drilling fluid properties compatible with the Design Space and satisfying one or more performance constraints; and
(iii) determining a Preferred Fluid Formulations Set comprising drilling fluid compositions having drilling fluid properties compatible with the Design Space and satisfying one or more customer criteria.

3. The method of claim 1, wherein (c) comprises:
ranking the drilling fluid compositions according to a weighted normalization based on the one or more Performance Criterion; and
populating the subset of drilling fluid compositions with higher ranked drilling fluid compositions.

4. The method of claim 1, further comprising:
(d) preparing samples of the selected subset of drilling fluid compositions; and
(e) testing the samples.

5. The method of claim 4, further comprising:
repeating (a) through (e) until desired test results are obtained.

6. The method of claim 1, wherein at least one neural network performs (b) and (c).

7. The method of claim 1, wherein the Design Space varies with time.

8. A designed drilling fluid, wherein the drilling fluid is designed by:
(a) determining a Design Space comprising specified ranges for one or more drilling fluid properties;
(b) determining a Final Fluid Formulations Set comprising drilling fluid compositions having drilling fluid properties compatible with the Design Space and satisfying one or more Performance Criterion; and
(c) selecting a subset of drilling fluid compositions from the Final Fluid Formulations Set.

9. The designed drilling fluid of claim 8, wherein (b) comprises at least one step selected from the group consisting of:
(i) determining a Fundamental Fluid Formulations Set comprising drilling fluid compositions having drilling fluid properties compatible with the Design Space and satisfying one or more supply parameters;
(ii) determining an Absolute Pass Fluid Formulations Set comprising drilling fluid compositions having drilling fluid properties compatible with the Design Space and satisfying one or more performance constraints; and
(iii) determining a Preferred Fluid Formulations Set comprising drilling fluid compositions having drilling fluid properties compatible with the Design Space and satisfying one or more customer criteria.

10. The designed drilling fluid of claim 8, wherein (c) comprises:
ranking the drilling fluid compositions according to a weighted normalization based on the one or more Performance Criterion; and
populating the subset of drilling fluid compositions with higher ranked drilling fluid compositions.

11. The designed drilling fluid of claim 8, further comprising:
(d) preparing samples of the selected subset of drilling fluid compositions; and
(e) testing the samples.

12. The designed drilling fluid of claim 11, further comprising:
repeating (a) through (e) until desired test results are obtained.

13. The designed drilling fluid of claim 8, wherein at least one neural network performs (b) and (c).

14. The designed drilling fluid of claim 8, wherein the Design Space varies with time.

15. A method of using a designed drilling fluid in a well bore in a subterranean formation, the method comprising:
designing a drilling fluid, wherein designing the drilling fluid comprises:
(a) determining a Design Space comprising specified ranges for one or more drilling fluid properties;
(b) determining a Final Fluid Formulations Set comprising drilling fluid compositions having drilling fluid properties compatible with the Design Space and satisfying one or more Performance Criterion; and
(c) selecting a subset of drilling fluid compositions from the Final Fluid Formulations Set; and
introducing the designed drilling fluid into the well bore.

16. The method of claim 15, wherein (b) comprises at least one step selected from the group consisting:
(i) determining a Fundamental Fluid Formulations Set comprising drilling fluid compositions having drilling fluid properties compatible with the Design Space and satisfying one or more supply parameters;
(ii) determining an Absolute Pass Fluid Formulations Set comprising drilling fluid compositions having drilling fluid properties compatible with the Design Space and satisfying one or more performance constraints; and
(iii) determining a Preferred Fluid Formulations Set comprising drilling fluid compositions having drilling fluid properties compatible with the Design Space and satisfying one or more customer criteria.

17. The method of claim 15, wherein (c) comprises:
ranking the drilling fluid compositions according to a weighted normalization based on the one or more Performance Criterion; and
populating the subset of drilling fluid compositions with higher ranked drilling fluid compositions.

18. The method of claim 15, further comprising:
(d) preparing samples of the selected subset of drilling fluid compositions;
(e) testing the samples; and
repeating (a) through (e) until desired test results are obtained.

19. The method of claim 15, wherein at least one neural network performs (b) and (c).

20. The method of claim 15, wherein the Design Space varies with time.
